(19) United States
(12) Patent Application Publication
(10) Pub. No.: US 2014/0145945 A1
(43) Pub. Date: May 29, 2014

(54) TOUCH-BASED INPUT CONTROL METHOD

(71) Applicant: LAONEX CO., LTD., Gyeonggi-do (KR)

(72) Inventor: Geun-Ho Shin, Gyeonggi-do (KR)

(73) Assignee: LAONEX CO., LTD., Gyeonggi-do, (KR)

(21) Appl. No.: 14/004,539

(22) PCT Filed: Dec. 11, 2012
(86) PCT No.: PCT/KR2012/010738

§ 371 Date: Sep. 11, 2013

(30) Foreign Application Priority Data
Mar. 20, 2012 (KR) 10-2012-0028219

(51) Int. Cl. G06F 3/01; G06F 3/041

(52) U.S. Cl. CPC G06F 3/017; G06F 3/041
USPC 345/157

(57) ABSTRACT

The present invention relates to touch-based input control technology in which cursor operation and pointer moving operation are properly identified by interpreting touch-based gesture in manipulating user terminals such as smart phones (e.g., i-phone) or smart pads (e.g., i-pad). According to the present invention, a user may easily, quickly and automatically control text input operation, cursor move operation and pointer move operation properly in context without cumbersome task of changing input modes.

### FIELD OF THE INVENTION

The present invention relates to touch-based user input control technology for user terminals such as smart phones or smart pads. More specifically, the present invention relates to touch-based input control technology in which cursor operation and pointer moving operation are properly identified by interpreting touch-based gesture in manipulating user terminals.

### BACKGROUND ART

It is general that mobile devices such as smart phones, MP3 players, PMP, PDA and smart pad provide multiple functions. Therefore, the mobile devices have a text input utility for inputting memo, scheduling or text message as well as an web search utility for acquiring information through Internet.

Conventional mobile devices generally install mechanical buttons for the text input utility. However, due to the mechanical restriction of small devices, users feel uncomfortable in using the mobile devices because two or three characters (consonants, vowels) are assigned to each button and the button size is very small.

Recently, mobile devices are including a large touch screen and a virtual keyboard on the touch screen for text input utility as in smart phones (e.g., i-phone) or smart pad (e.g., i-pad). Due to the Android platform, it is expected that more mobile devices will include touch screen device for text input utility. Further, Apple accessories are actively adopting trackpad device. Therefore, it is also expected that touch-based data input technology will be more widely spread. In this specification, the touch devices means touch-based data input means such as touch screen or trackpad.

In most cases, touch-based mobile devices do not include additional mechanical buttons. For example, with a variety of soft buttons being displayed for function control and user manipulation, a user may touch the soft button in order to execute a corresponding command or may control the trackpad in order to input data.

Recently, multi-touch touch screens are widely used in mobile devices. In multi-touch technology, a user may control mobile devices by using multiple fingers. As such, the touch-based data input technology is steadily developing.

However, in order to change the location of an edit cursor or in order to move a control pointer on display, a user shall change the input mode each time. It is very common that a user modifies operation context while inputting texts in mobile devices. Therefore, due to the repetitive changing of the input mode, even for simple text phrase, the text inputting becomes very cumbersome and time-consuming.

Therefore, a touch-based technology for mobile devices is needed so that a user may properly control locations of edit cursor or control pointer easily and quickly without cumbersome task of changing input modes.

### REFERENCE TECHNOLOGIES

1. Portable data input device (KR patent application No. 10-2010-0025169)

2. Mobile communication terminal and multi-touch editing method for the same (KR patent application No. 10-2009-0072076)

### DISCLOSURE OF INVENTION

### Technical Problem

It is an object of the present invention to provide touch-based user input control technology for user terminals such as smart phones or smart pads. More specifically, it is an object of the present invention to provide touch-based input control technology in which cursor operation and pointer moving operation are properly identified by interpreting touch-based gesture in manipulating user terminals.

### Technical Solution

According to the present invention, there is provided a touch-based input control method comprises: a first step of implementing a virtual keyboard in a touch device; a second step of identifying user touch input in a screen in which the virtual keyboard is displayed; a third step of identifying moving of the user touch; a fourth step of processing a keyboard stroke for a character in the virtual keyboard corresponding to the touch location if the touch becomes released without a predetermined threshold-over event for the user touch; a fifth step of identifying input mode when the threshold-over event happens for the user touch; and a sixth step of moving edit cursor corresponding to the moving direction of the user touch if the input mode is keyboard input mode.

The present invention may further comprises: a seventh step of moving control pointer corresponding to the moving direction and the moving distance of the user touch if the input mode is focus control mode.

Further, according to the present invention, there is provided a touch-based input control method comprises: a first step of implementing a virtual keyboard in a touch device; a second step of identifying multi-touch input on the virtual keyboard; a third step of identifying moving of the multi-touch; a fourth step of checking whether the multi-touch is released without identifying a predetermined threshold-over event for the multi-touch; a fifth step of, when a first location of the multi-touch is moving and a second location of the multi-touch is released, moving edit cursor corresponding to the touch-moving direction of the first location of the multi-touch with configuring the input mode into keyboard input mode; and a sixth step of, when the first location of the multi-touch is released and the a second location of the multi-touch is moving, moving control pointer corresponding to the direction and distance of the touch-moving of the second location with configuring the input mode into focus control mode.

In the present invention, the threshold-over event includes at least one of a first event and a second event, wherein the first event is that the moving distance of the user touch crosses a predetermined threshold distance, and wherein the second event is that the keep time of the user touch elapses a predetermined threshold time.

### Advantageous Effects

According to the present invention, a user may easily, quickly and automatically control text input operation, cursor move operation and pointer move operation properly in context without cumbersome task of changing input modes.

### BRIEF DESCRIPTION OF THE DRAWINGS

FIG. 1 is a block diagram of a user terminal according to the present invention.

FIG. 2 shows implementation of a virtual keyboard on a touch screen

FIG. 3 shows inputting text using the virtual keyboard.

FIG. 4 shows scrolling up/down by multi-touch.

FIG. 5 shows moving of edit cursor in keyboard input mode.

FIG. 6 shows moving of mouse pointer in focus control mode.

FIG. 7 shows implementation of left-click and right-click operations by multi-touch in focus control mode.

FIG. 8 shows block defining by multi-touch.

FIG. 9 shows edit function by multi-touch.

FIG. 10 shows a flowchart of input control method based on single-touch in the present invention.

FIG. 11 shows a flowchart of input control method based on multi-touch in the present invention.

FIG. 12 shows moving of icon focusing in main menu by touch inputs according to the present invention.

### EMBODIMENT FOR CARRYING OUT THE INVENTION

The present invention is described below in detail with reference to the drawings.

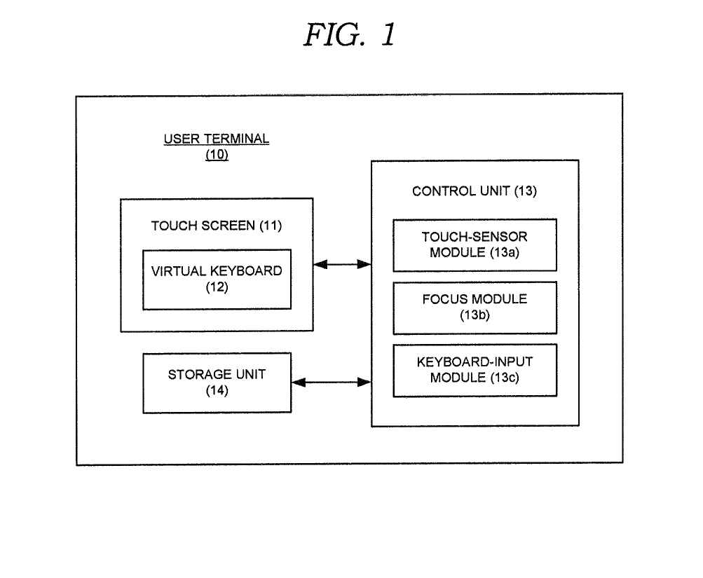

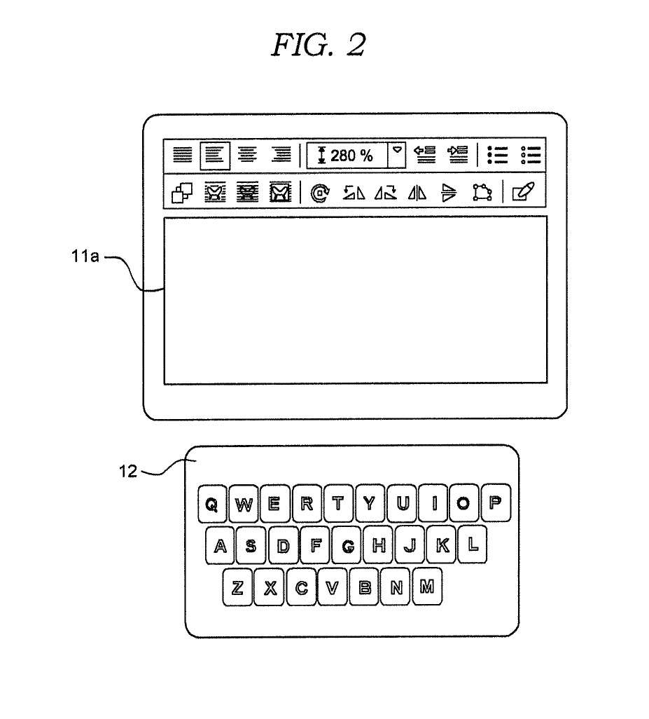

FIG. 1 is a block diagram of a user terminal which is adapted for the touch-based input control method according to the present invention. FIGS. 2 to 9 shows user interface (U1) of a touch screen 11 in a user terminal 10 in which the touch-based input control method according to the present invention is implemented.

Referring to FIG. 1, the user terminal 10 includes touch screen 11, control unit 13 and storage unit 14.

A virtual keyboard 12 is implemented on the touch screen 11. The touch screen 11 is exemplarily set forth for touch devices. The touch screen 11 generally includes both a touch input unit and a display unit. However, it may only include a touch input unit.

The virtual keyboard 12 generally means a keyboard in which keyboard character set is displayed on the touch screen 11 and touching the keyboard character set results in inputting characters. However, the virtual keyboard 12 in the present invention further includes a PI (physical interface)-type keyboard in which the keyboard character set is printed on a sticker and the sticker is attached on the touch screen 11.

The virtual keyboard 12 may be formed in qwerty style as shown in FIG. 2. Responding to user's touch inputs on the virtual keyboard 12, text sentence is written on the text-input area 11a. It is general that the text-input area 11a and the virtual keyboard 12 are implemented on the touch screen 11 of the user terminal 10. However, they may be separately implemented in respective hardware, and may cooperatively operate with being connected via a network (e.g., Bluetooth) the present invention.

The virtual keyboard 12 processes touch-based text input function, and further identifies input mode out of the interpretation of the touch gesture operations in the control unit 13. Therefore, neither of mode conversion key nor mode-setting operation is necessary in the present invention, which renders text edit convenient.

The control unit 13 includes touch-sensor module 13a, focus module 13b, keyboard-input module 13c. In this specification, two embodiments are described in view of operations of the control unit 13, in which single-touch operations on the virtual keyboard 12 is used in the first embodiment and multi-touch operations on the virtual keyboard 12 is used in the second embodiment.

The storage unit 14 provides space for storing control program codes or various data for operation of the user terminal 10, and may includes RAM, ROM, flash memory, hard disk, memory cards, webdisk, cloud disk etc.

The 1^{st} Embodiment: Single-touch-based Input Control

The touch-sensor module 13a implements virtual keyboard 12 on the touch screen 11 for user operations. The touch-sensor module 13a identifies touch input events on a display in which the virtual keyboard 12 is implemented.

When identifying a touch input event, the touch-sensor module 13a identifies the touch coordinate in the touch screen 11 and the character in the virtual keyboard 12 corresponding to the touch location, which are then temporarily stored in the storage unit 14.

Then, when identifying that user's touch is moving from the initial touch location, the touch-sensor module 13a monitors whether the movement crosses a predetermined threshold distance (allowable range).

In case the touch point is released within the threshold distance from the initial touch location, the keyboard-input module 13c controls the touch screen 11 so that a keyboard stroke is identified and processed for the character in the virtual keyboard 12 corresponding to the touch location.

However, in case the touch point has moved with crossing the threshold distance from the initial touch location, the touch-sensor module 13a identifies the current input mode, i.e., keyboard input mode or focus control mode. Although the input mode may be explicitly configured, it is more general that the control unit 13 identifies the input mode by interpreting operation context of the user terminal 10.

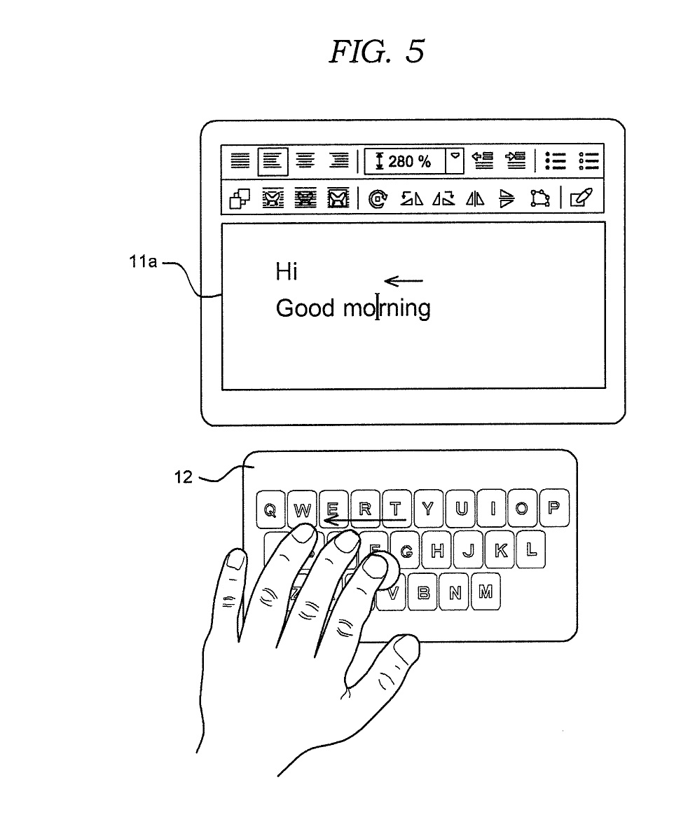

In keyboard input mode, the keyboard-input module 13c controls the touch screen 11 so that edit cursor moves among characters in the text as similarly shown in FIG. 5. Responding to moving of the edit cursor, it is preferable that input mode is automatically configured into keyboard input mode. Then, the control unit 13 checks whether the touch is released. In case the touch is released, the keyboard-input module 13c controls the virtual keyboard 12 so that the moving of edit cursor pauses and then a text edit begins in the current location.

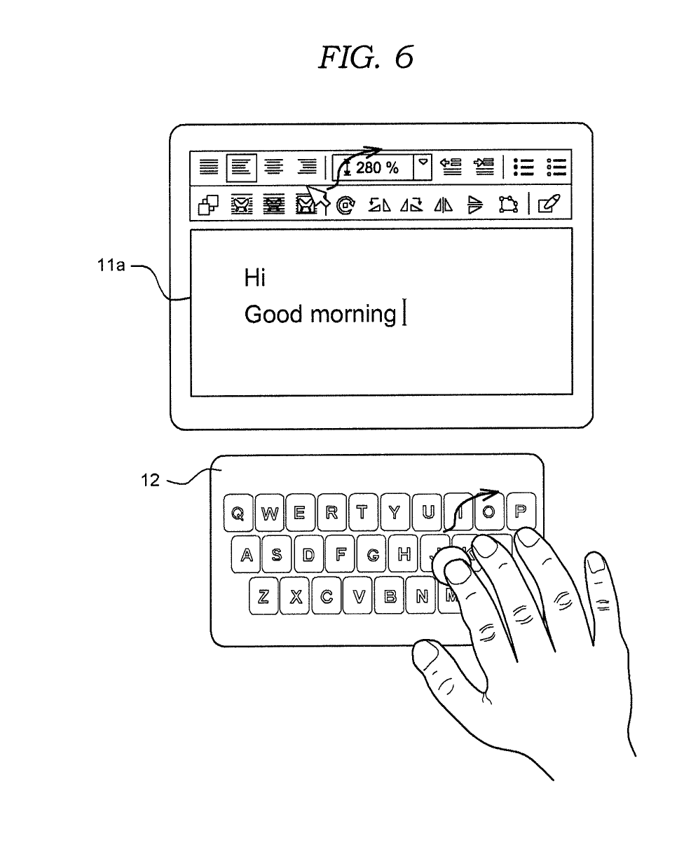

In the focus control mode, the focus module 13b moves control pointer corresponding to the moving direction and moving distance as similarly shown in FIG. 6. Responding to moving of the control pointer, it is preferable that input mode is automatically configured into focus control mode.

In the present invention, the control pointer may be implemented in a form of a mouse pointer or any invisible forms. The position of the control pointer may be implemented at the same location that of the touch point. Alternatively, the position of the control pointer may be implemented at a different location, with corresponding only to the moving direction and moving distance. Further, the moving distance of the control pointer may be configured with corresponding to a moving distance exceeding the threshold distance from the initial touch point. Then, the focus module 13b checks whether the touch is released. In case the touch is released, the focus module 13b controls the touch screen 11 so that a control focusing is achieved in the touch-release location.

Alternatively, rather than checking whether the moving distance of touch point has crossed a threshold distance (allowable range), it is also available in the present invention to checking whether the keep time of user touch has elapsed a predetermined threshold time (allowable period). That also applies to the second embodiment. The situation where the moving distance of touch point has crossed a threshold distance (allowable range) or the keep time of user touch has elapsed a predetermined threshold time (allowable period) may be referenced as threshold-over event.

### The 2^{nd} Embodiment: Multi-touch-based Input Control

The touch-sensor module 13a implements a virtual keyboard 12 on a touch screen 11 responding to user operation. Then, the touch-sensor module 13a identifies multi-touch input on the virtual keyboard 12.

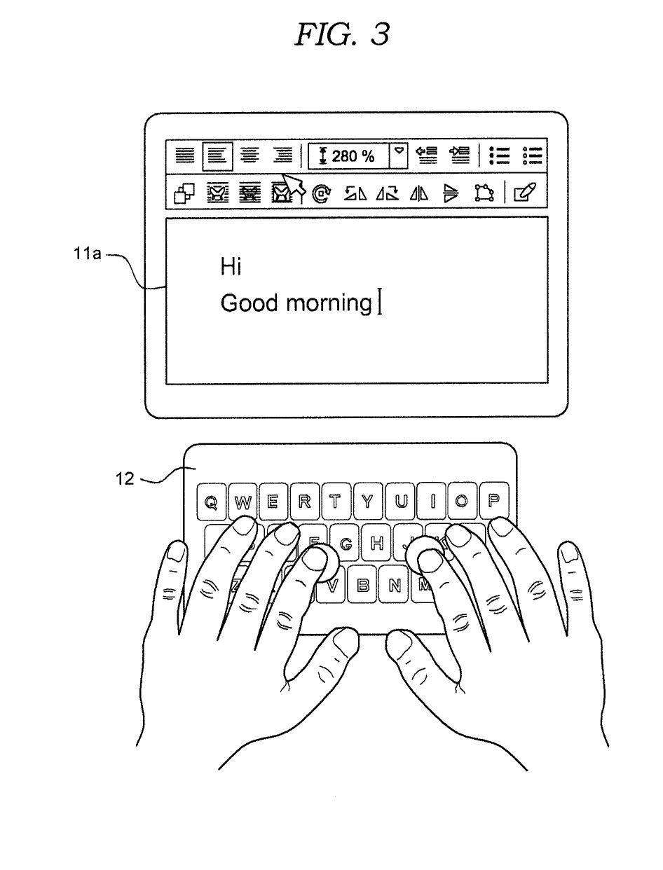

When identifying a multi-touch input for two points on the virtual keyboard 12 as shown in FIG. 3, the touch-sensor module 13a temporarily stores in the storage unit 14 the touch coordinates of two points in the touch screen 11 corresponding to the multi-touch locations.

The touch-sensor module 13a monitors each touch point moves from its initial touch location, and then checks whether the moving distance of the touch points have crossed a threshold distance (allowable range).

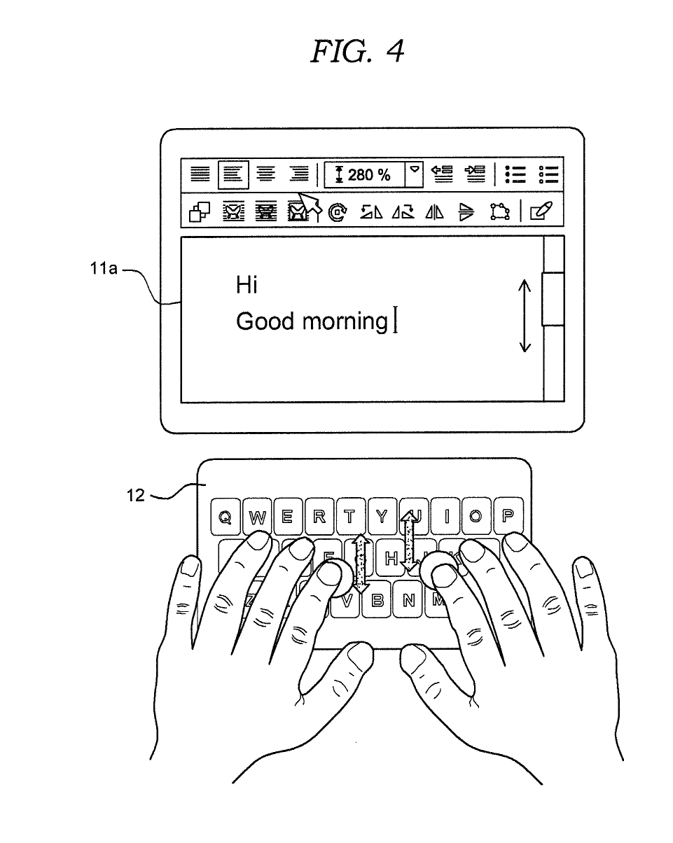

In case the multi-touch's moving distance has already crossed the threshold distance, with understanding that user is simultaneously moving both figures, as shown in FIG. 4, the touch-sensor module 13a controls the touch screen 11 so that scroll up/down/left/right or page up/down is implemented responding to the multi-touch moving.

However in case the multi-touch's moving distance has not yet crossed the threshold distance, the touch-sensor module 13a checks whether touch-release events happen for all of the multi-touch points.

In case touch-release event happen for all the multi-touch points, the touch-sensor module 13a waits a re-touch in the multi-touch locations. When the re-touch enters, the touch-sensor module 13a identifies the re-touch event.

First, in case a re-touch for the left point of the multi-touch is identified, the keyboard-input module 13c controls the touch screen 11 so that edit cursor moves according to the touch-moving direction of the re-touch of the left-point as shown in FIG. 5. Responding to moving of the edit cursor, it is preferable that input mode is automatically configured into keyboard input mode.

In case a re-touch for the right point of the multi-touch is identified, the focus module 13b controls the touch screen 11 so that control pointer moves according to the touch-moving direction of the re-touch of the right-point as shown in FIG. 6. Responding to moving of the control pointer, it is preferable that input mode is automatically configured into focus control mode.

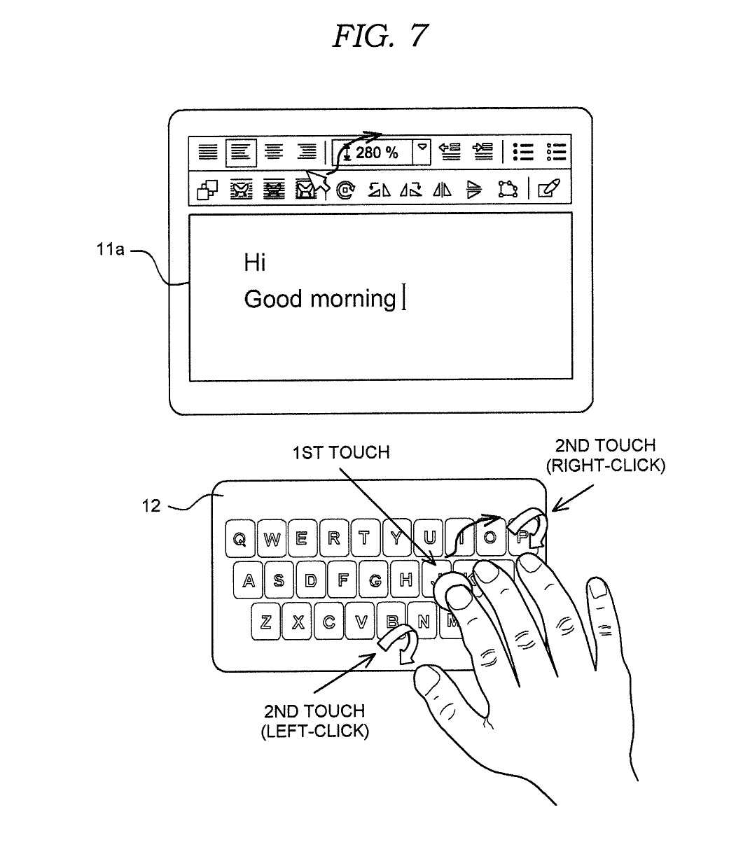

Further, when the input mode becomes focus control mode by single-touch-based or multi-touch-based operation scenarios, a second touch may implement left-click operation or right-click operation. As shown in FIG. 7, with referencing a touch operation for moving control pointer in the focus control mode as a first touch, a left-click operation or a right-click operation is implemented by a second touch which is provided in the left or right area of the first touch.

Further, in case only one of the multi-touch is released, the touch screen 11 is controlled so as to move edit cursor or control pointer respectively.

First, in case the right point of the multi-touch is released and the left point of the multi-touch is moving, as shown in FIG. 5, the keyboard-input module 13c controls the touch screen 11 so that edit cursor moves according to the touch-moving direction of the left point. Responding to moving of the edit cursor, it is preferable that input mode is automatically configured into keyboard input mode.

In case the left point of the multi-touch is released and the right point of the multi-touch is moving, as shown in FIG. 6, the focus module 13b controls the touch screen 11 so that control pointer moves according to the touch-moving direction of the right-point. Responding to moving of the control pointer, it is preferable that input mode is automatically configured into focus control mode.

In the present invention, text blocks may be defined or edit function may be utilized through multi-touch operations.

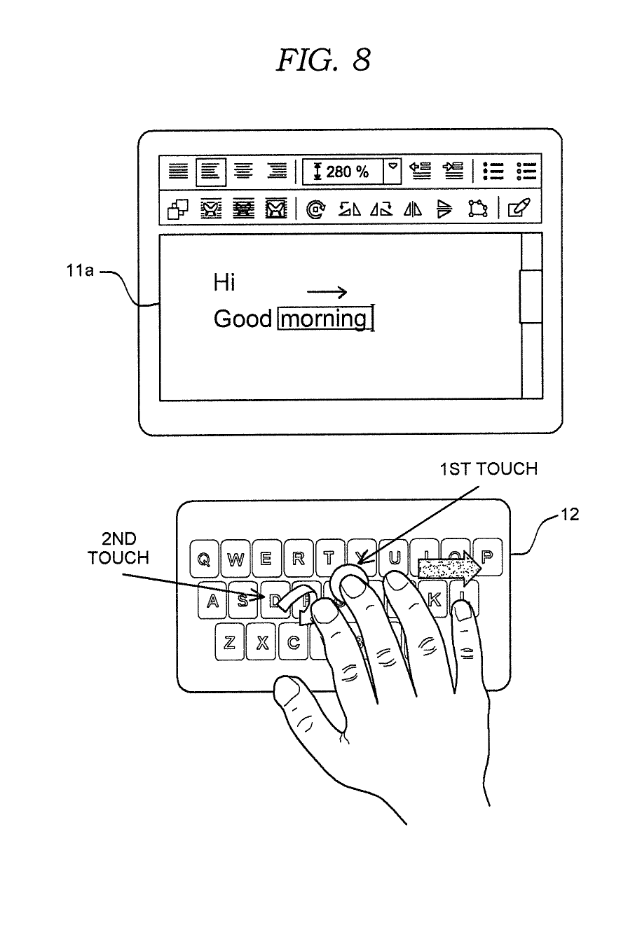

First, after configuring input mode into keyboard input mode on the text-input area 11a, the keyboard-input module 13c may define text block by multi-touch operation. Referring to FIG. 8, after providing a second left touch in a touch state (referenced as ‘sequential multi-touch’ in this specification), a user consecutively may move (or drag) to the left or to the right these multi-touch points. Then, the keyboard-input module 13c may define a block in the text sentence. In FIG. 8, text block “morning” is defined by multi-touch operation and right-drag operation.

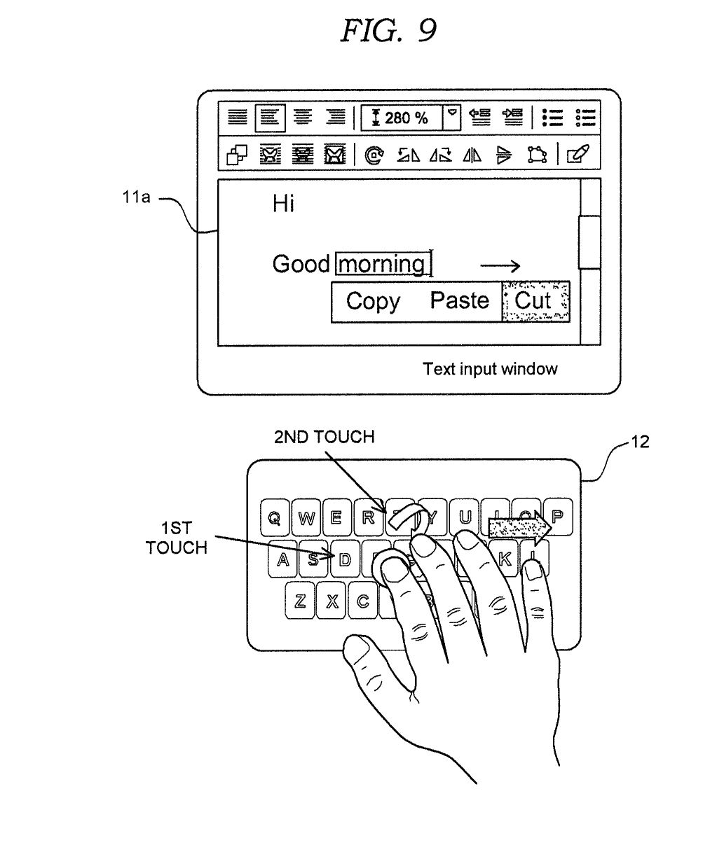

And, after configuring input mode into focus control mode on the text-input area 11a, the focus module 13b may define text block by user operations. Referring to FIG. 9, after edit function (copy/paste/cut) window popping up by a second left touch in a touch state, a user consecutively move these multi-touch points. Then, one of the edit functions may be selected out of the edit function window. In FIG. 9, the focus module 13b selects and activates the edit function “Cut” for the text block by these operation as above.

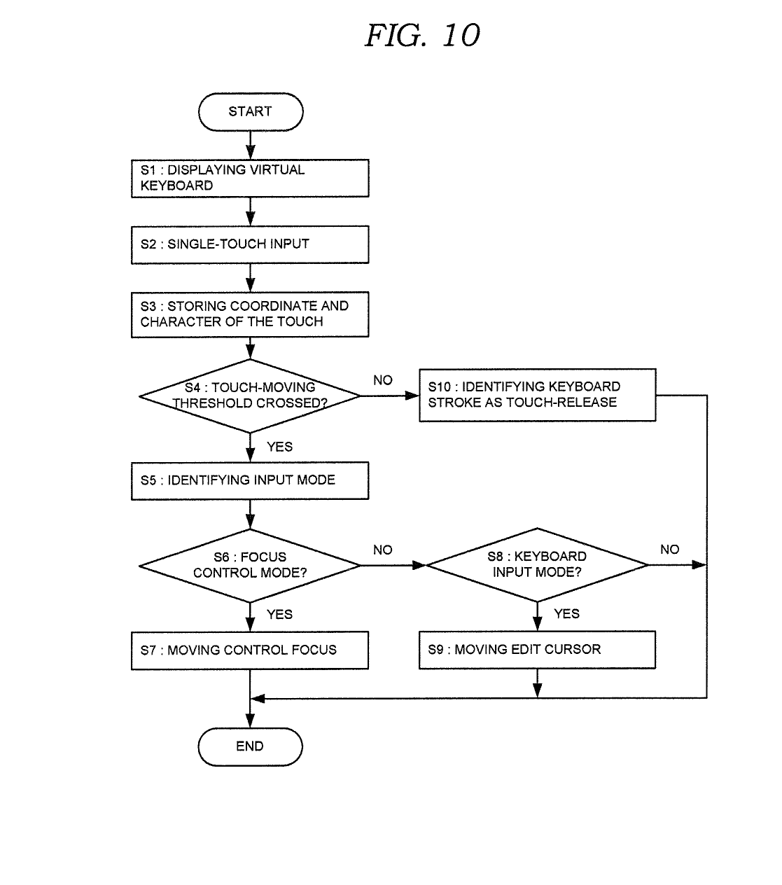

FIG. 10 shows a flowchart of input control method based on single-touch in the present invention. First, the control unit 13 implements a virtual keyboard on a touch screen 11 upon user request (S1). Besides the touch screen 11, the technology of the present invention may be generally implemented by touch devices, e,g. trackpad.

Then, the control unit 13 identifies single-touch input in a screen in which the virtual keyboard 12 is displayed (S2).

Identifying the single-touch in step (S2), the control unit 13 temporarily stores in the storage unit 14 the touch coordinate in the touch screen 11 and the character in the virtual keyboard 12 corresponding to the single-touch location (S3).

Then, the control unit 13 checks whether the moving distance of user touch has crossed a threshold distance (allowable range) from initial touch location of the single-touch (S4). In case the single-touch is released within the threshold distance, the control unit 13 controls the touch screen 11 so that a keyboard stroke is identified and processed for the character in the virtual keyboard 12 corresponding to the touch location (S10).

However, in case the single-touch has moved with crossing the threshold distance in step (S4), the control unit 13 identifies the current input mode (S5).

In case the input mode is focus control mode (S6), the control unit 13 moves control pointer (control focus) corresponding to the moving direction and moving distance of the single-touch (S7). The control pointer may be implemented in a form of a mouse pointer or any invisible forms. The position of the control pointer may be implemented at the same location that of the touch point. Alternatively, the position of the control pointer may be implemented at a different location, with corresponding only to the moving direction and moving distance. Further, the moving distance of the control pointer may be configured with corresponding to a moving distance exceeding the threshold distance from the initial touch point. Then, the control unit 13 checks whether the touch is released. In case the touch is released, the control unit 13 controls the touch screen 11 so that a control focusing is achieved in the touch-release location.

However, in case the input mode is keyboard input mode (S8), as similarly shown in FIG. 6, the control unit 13 moves the edit cursor among characters in the text. Then, the control unit 13 checks the touch is released. In case the touch is released, the control unit 13 controls the virtual keyboard 12 so that the moving of edit cursor pauses and then a text edit begins in the current location.

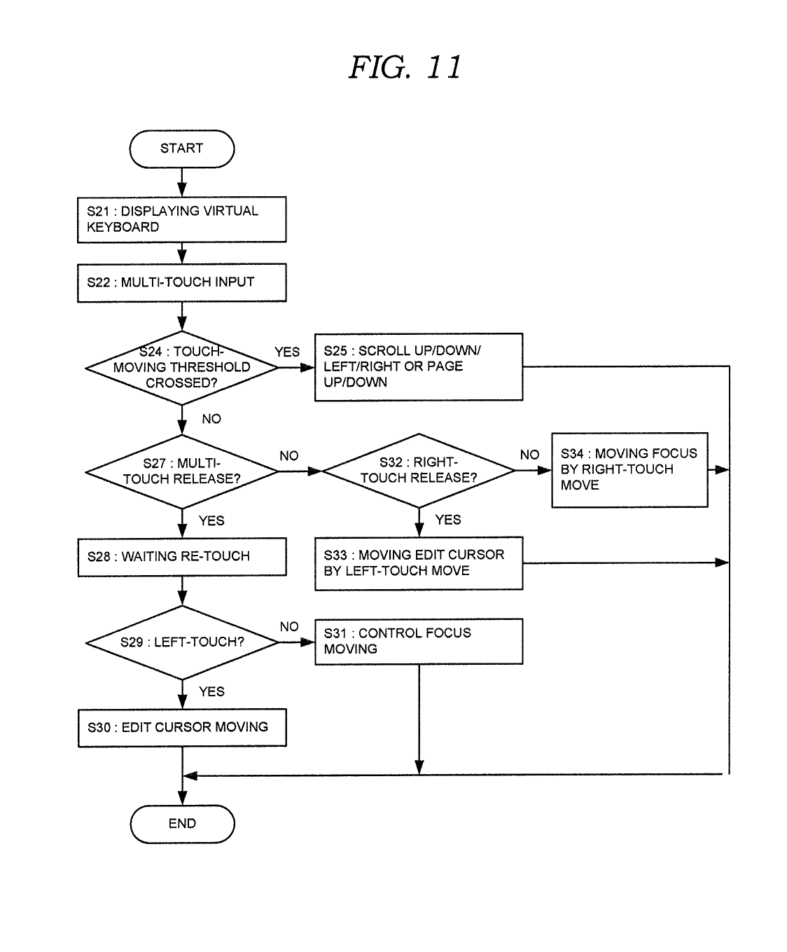

FIG. 11 shows a flowchart of input control method based on multi-touch in the present invention. First, the control unit 13 displays a virtual keyboard on a touch screen 11 upon user request (S21).

Then, the control unit 13 identifies multi-touch input in a screen in which the virtual keyboard 12 is displayed (S22).

Identifying the multi-touch in step (S22), the control unit 13 checks whether the moving distance of user touch has crossed a threshold distance (allowable range) from initial touch location of the multi-touch (S24).

In case the multi-touch's moving distance has already crossed the threshold distance, as shown in FIG. 4, the control unit 13 controls the touch screen 11 so that scroll up/down/left/right or page up/down is implemented responding to the user's touch-moving operation (S25).

However in case the multi-touch's moving distance has not yet crossed the threshold distance, the control unit 13 checks whether all of the multi-touch have released (S27).

In case any of the multi-touch has not yet released, the control unit 13 then checks whether any one of the multi-touch has released (S32).

In step (S32), the control unit 13 checks whether right-touch of the multi-touch has released. If the right-touch has released with the left-touch being identified as moving, the control unit 13 controls the touch screen 11 so that edit cursor moves according to the touch-moving direction of the left-touch point as shown in FIG. 5 (S33). Responding to moving of the edit cursor, it is preferable that input mode is automatically configured into keyboard input mode.

If the left-touch has released with the right-touch being identified as moving, the control unit 13 controls the touch screen 11 so that control pointer moves according to the direction and distance of the touch-moving of the right-touch point as shown in FIG. 6 (S34). Responding to moving of the control pointer, it is preferable that input mode is automatically configured into focus control mode.

However, in case all the multi-touch have released, the control unit 13 waits a re-touch in the multi-touch location (S28). When the re-touch enters, the control unit 13 identifies the re-touch event.

First, in case a re-touch for the left point of the multi-touch is identified (S29), the control unit 13 controls the touch screen 11 so that edit cursor moves according to the touch-moving direction of the re-touch of the left-point as shown in FIG. 5 (S30). Responding to moving of the edit cursor, it is preferable that input mode is automatically configured into keyboard input mode.

In case a re-touch for the right point of the multi-touch is identified (S29), the control unit 13 controls the touch screen 11 so that control pointer moves according to the touch-moving direction of the re-touch of the right-point as shown in FIG. 6 (S31). Responding to moving of the control pointer, it is preferable that input mode is automatically configured into focus control mode.

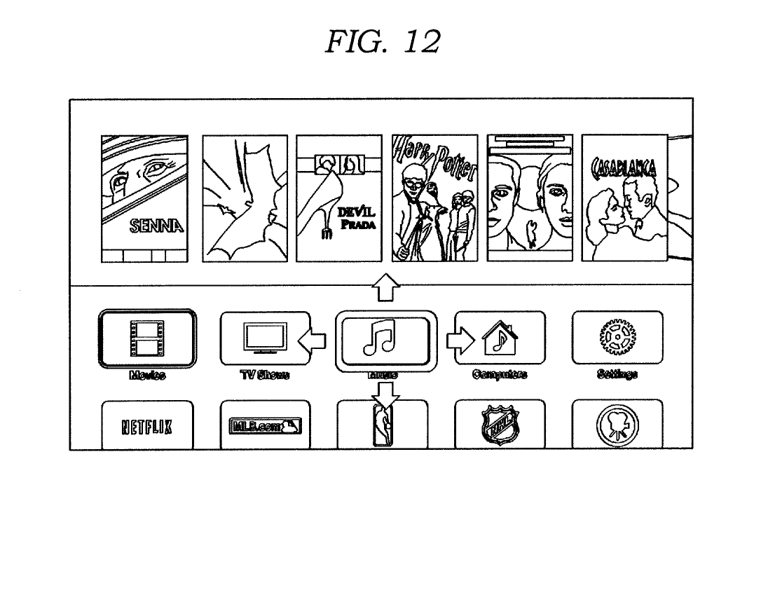

FIG. 12 shows moving of icon focusing in main menu by touch inputs according to the present invention.

As described above, a control pointer in the focus control mode may be implemented in various ways according to the present invention. That is, it may be implemented in a form of a mouse pointer or any invisible forms as in FIG. 12.

Currently, most of smart terminals (e.g., smart phone, smart pad, tablet computer, smart box, smart TV) adopts icons for user interface. In this embodiment, focus moving between icons and execution control of a focused icon is achieved by touch operations in main menu of user terminal.

In the embodiment shown in FIG. 12, a user may input texts in application display, e.g., in order to configure icon names. The touch-based input control technology as described above with referring to FIGS. 1 to 11 are advantageously adopted for selective switching between keyboard input mode and focus control mode, text inputting, edit cursor moving, and control pointer moving among icons.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

1. A touch-based input control method, comprising:
a first step of implementing a virtual keyboard in a touch device;
a second step of identifying user touch input in a screen in which the virtual keyboard is displayed;
a third step of identifying moving of the user touch;
a fourth step of processing a keyboard stroke for a character in the virtual keyboard corresponding to the touch location if the touch becomes released without a predetermined threshold-over event for the user touch;
a fifth step of identifying input mode when the threshold-over event happens for the user touch; and
a sixth step of moving edit cursor corresponding to the moving direction of the user touch if the input mode is keyboard input mode.

2. The touch-based input control method according to claim 1, wherein the threshold-over event includes at least one of a first event and a second event, wherein the first event is that the moving distance of the user touch crosses a predetermined threshold distance, and wherein the second event is that the keep time of the user touch elapses a predetermined threshold time.

3. The touch-based input control method according to claim 2, further comprising:
a seventh step of moving control pointer corresponding to the moving direction and the moving distance of the user touch if the input mode is focus control mode.

4. The touch-based input control method according to claim 3, wherein in the seventh step the moving distance of the control pointer is configured corresponding to a moving distance exceeding the threshold distance from the initial touch point of the user touch.

5. The touch-based input control method according to claim 4, further comprising:
a eighth step of implementing left-click or right-click operations corresponding to the left or right multi-touch input respectively following a user touch for moving of control pointer in the focus control mode.

6. The touch-based input control method according to claim 2, further comprising:
a ninth step of defining a text block in the location of the edit cursor in keyboard input mode, wherein the text block is defined by consecutively identifying a sequential multi-touch in a predetermined first order on the touch device and then moving the multi-touch points to the left or right, and wherein the text block is defined from the edit cursor to the moving direction of the multi-touch points.

7. The touch-based input control method according to claim 6, further comprising:
a tenth step of, when sequential multi-touch is formed in a predetermined second order on the touch device and then the multi-touch points are moving to the left or to the right, implementing an edit function window for the text block so as to select an edit function corresponding to the moving direction to the left or to the right.

8. The touch-based input control method, comprising:
a first step of implementing a virtual keyboard in a touch device;
a second step of identifying multi-touch input on the virtual keyboard;
a third step of identifying moving of the multi-touch;
a fourth step of checking whether the multi-touch is released without identifying a predetermined threshold-over event for the multi-touch;
a fifth step of, when a first location of the multi-touch is moving and a second location of the multi-touch is released, moving edit cursor corresponding to the touch-moving direction of the first location of the multi-touch with configuring the input mode into keyboard input mode; and
a sixth step of, when the first location of the multi-touch is released and the a second location of the multi-touch is moving, moving control pointer corresponding to the direction and distance of the touch-moving of the second location with configuring the input mode into focus control mode.

9. The touch-based input control method according to claim 8, further comprising:
a seventh step of waiting for a re-touch in the multi-touch locations if the multi-touch is released in the fourth step;
a eighth step of, if identifying the re-touch in a predetermined first location of the multi-touch, moving edit cursor corresponding to the moving direction of the re-touch in the first location with configuring the input mode into keyboard input mode; and
a ninth step of, if identifying the re-touch in a predetermined second location of the multi-touch, moving control pointer corresponding to the moving direction and distance of the re-touch with configuring the input mode into focus control mode.

10. The touch-based input control method according to claim 9, wherein the threshold-over event includes at least one of a first event and a second event, wherein the first event is that the moving distance of the user touch crosses a predetermined threshold distance, and wherein the second event is that the keep time of the user touch elapses a predetermined threshold time.

11. The touch-based input control method according to claim 10, further comprising:
a tenth step of identifying scroll up/down or page up/down commands if the moving distance of the multi-touch crosses the threshold distance.

12. The touch-based input control method according to claim 10, further comprising:
a eleventh step of defining a text block in the location of the edit cursor in keyboard input mode, wherein the text block is defined by consecutively identifying a sequential multi-touch in a predetermined first order on the touch device and then moving the multi-touch points to the left or right, and wherein the text block is defined from the edit cursor to the moving direction of the multi-touch points.

13. The touch-based input control method according to claim 11, further comprising:
a twelfth step of, when sequential multi-touch is formed in a predetermined second order on the touch device and then the multi-touch points are moving to the left or to the right, implementing an edit function window for the text block so as to select an edit function corresponding to the moving direction to the left or to the right.

14. A computer-readable recording medium storing a program for executing the touch-based input control method according to claim 1.
